(19) United States
(12) Patent Application Publication
(10) Pub. No.: US 2012/0096734 A1
(43) Pub. Date: Apr. 26, 2012

(54) LAUNDRY TREATING MACHINE

(75) Inventors: Jung Wook Moon, Gyeongsangnam-do (KR); Chang Gyu Choi, Gyeongsangbuk-do (KR); Kwang Hee Lee, Gyeongsangbuk-do (KR); Hye Yong Park, Gyeongsangbuk-do (KR); Hyung Gyu Lim, Gyeongsangbuk-do (KR); Seung Gyu Ryu, Gyeongsangbuk-do (KR)

(73) Assignee: LG ELECTRONICS INC., Seoul (KR)

(21) Appl. No.: 13/145,981

(22) PCT Filed: Jan. 22, 2010
(86) PCT No.: PCT/KR2010/000428

§ 371 Date: Jan. 12, 2012

(30) Foreign Application Priority Data
Jan. 23, 2009 (KR) 10-2009-0005939
Dec. 15, 2009 (KR) 10-2009-0124663

(51) Int. Cl. F26B 25/06

(52) U.S. Cl. 34/218

(57) ABSTRACT

A laundry treating machine is disclosed. A laundry treating machine includes a cabinet comprising an accommodating space formed therein to accommodate laundry, a door rotatably coupled to a front surface of the cabinet, an air supply device for supplying air or heated air to the accommodating space, and first and second hinge parts, the first hinge part selectively provided in one of two couples of diagonally opposite front corners of the cabinet and the second hinge part provided in the other one.

### TECHNICAL FIELD

The present invention relates to a laundry treating machine.

### BACKGROUND ART

In recent, diverse types of laundry treating machines have been consumed together with washing machines for washing laundry. For example, there are drum type dryers for drying washed laundry, cabinet type dryers for drying laundry hung therein and refreshers for refreshing laundry by supplying heated air to laundry. However, such a cabinet type laundry treating machine has several disadvantages and the present invention is invented to solve these disadvantages.

### DISCLOSURE

### Technical Problem

To solve the problems, an object of the present invention is to provide a laundry treating machine assembled simply and fabricated efficiently.

### Technical Solution

To achieve these objects and other advantages and in accordance with the purpose of the invention, as embodied and broadly described herein, a laundry treating machine includes a cabinet comprising an accommodating space formed therein to accommodate laundry; a door rotatably coupled to a front surface of the cabinet; an air supply device for supplying air or heated air to the accommodating space; and first and second hinge parts, the first hinge part selectively provided in one of two couples of diagonally opposite front corners of the cabinet and the second hinge part provided in the other one.

### Advantageous Effects

The present invention has following advantageous effects. According to the laundry treating machine according to the present invention, if the user wishes to change the rotational direction of the door when connecting the door to the cabinet, the only thing he/she has to do is to change the locations of the hinge parts, without fabricating any new hinge parts. As a result, the fabrication assembly may be simple and efficient. In addition, the production cost may be reduced when fabricating the laundry treating machine.

### DESCRIPTION OF DRAWINGS

The accompanying drawings, which are included to provide further understanding of the disclosure and are incorporated in and constitute a part of this application, illustrate embodiments of the disclosure and together with the description serve to explain the principle of the disclosure.

In the drawings:

FIG. 1 is a front view illustrating a laundry treating machine according to an exemplary embodiment of the present invention;

FIG. 2 is a front view illustrating a laundry treating machine according to another embodiment of the present invention;

FIG. 3 is a perspective view illustrating a moving hanger shown in FIG. 2;

FIG. 4 is an exploded perspective view of FIG. 3;

FIG. 5 is a diagram schematically illustrating an inner configuration of a mechanism compartment;

FIG. 6 is a diagram schematically illustrating a top of a laundry treating machine according to a further embodiment of the present invention;

FIG. 7 is an enlarged perspective view partially illustrating an upper hinge part shown in FIG. 6;

FIG. 8 is an exploded perspective view of FIG. 7;

FIG. 9 is a sectional view of FIG. 7;

FIG. 10 is a diagram schematically illustrating arrangement of a wire provided in the laundry treating machine shown in FIG. 6;

FIG. 11 is a perspective view illustrating a lower hinge part of the laundry treating machine shown in FIG. 6;

FIG. 12 is an exploded perspective view of FIG. 11;

FIG. 13 is a diagram schematically illustrating a rotational state in case the lower hinge part is provided in a lower left portion of a cabinet;

FIG. 14 is a diagram schematically illustrating a rotational state in case the lower hinge part is provided in a lower right portion of the cabinet;

FIG. 15 is a diagram schematically illustrating a couple of hinge parts provided in upper and lower portions of a door composing a laundry treating machine according to a still further embodiment of the present invention, respectively;

FIG. 16 is an exploded perspective view illustrating a first hinge;

FIG. 17 is a low perspective view illustrating the first hinge;

FIG. 18 is a perspective view illustrating a rotation supporter;

FIG. 19 is a low perspective view illustrating an extended part of the first hinge;

FIG. 20 is a perspective view partially illustrating the first hinge and a rotation limiting part in case the door is rotated;

FIG. 21 is a sectional view of FIG. 20; and

FIG. 22 is a perspective view illustrating an inside of a frame having the first hinge coupled thereto.

### BEST MODE

As follows, a laundry treating machine according to an exemplary embodiment of the present invention will be described in reference to the accompanying drawings.

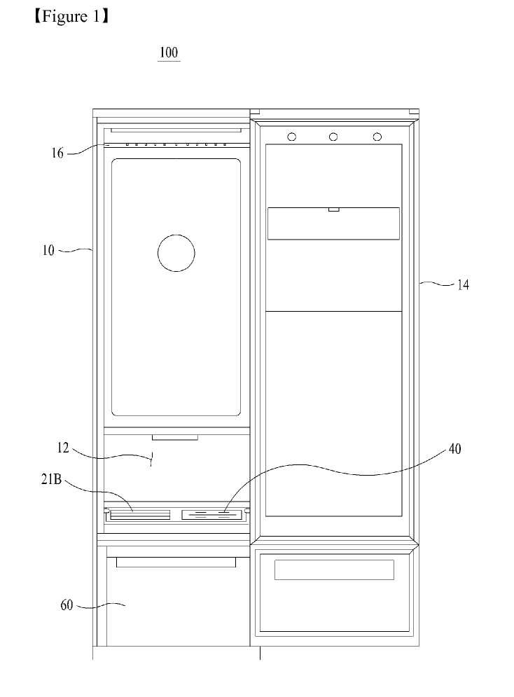

FIG. 1 is a front view illustrating the laundry treating machine according to the exemplary embodiment, with an open door 14.

This specification describes a refresher for refreshing laundry by supplying heated air, as laundry treating machine, and the present invention is not limited thereto. A subject matter of the present invention may be applicable to other types of machines having a heat pump which will be described later. Here, the term ‘refresh’ may mean a process performed to remove wrinkles, deodorize, sanitize, prevent static electricity or warm laundry, with supplying air, heated air, water, mist, steam and the like to the laundry. Also, the term ‘laundry’ mentioned in the present specification includes wearable objects including clothes, apparel, shoes, socks, gloves, hats and mufflers and fabric object used by a human including dolls, towels, beddings and the all kinds of washing objects.

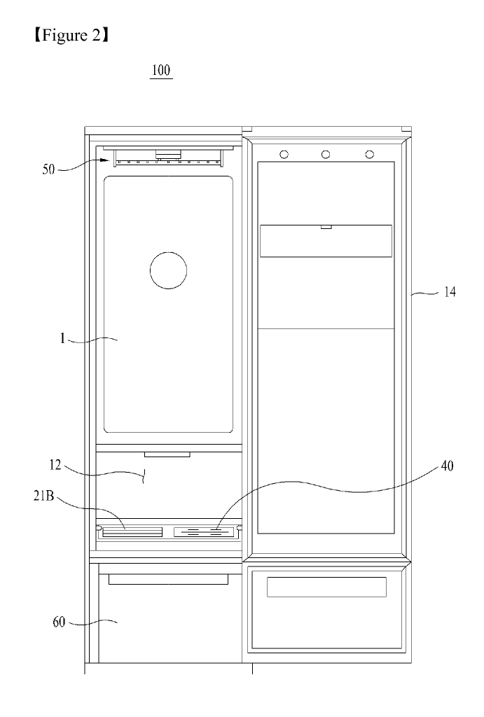

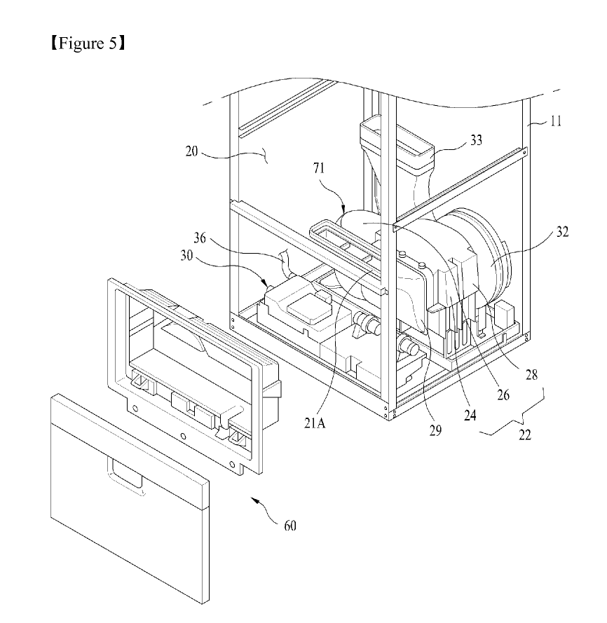

In reference to FIG. 1, the laundry treating machine 100 according to this embodiment of the present invention includes a cabinet 10, an air supply device (22, see FIG. 5), a moisture generating device (30, see FIG. 2) and a control part (not shown) the cabinet 10 includes an accommodating space 12 to receive laundry therein. The air supply device 22 supplies air or heated air to the accommodating space 12 and the moisture generating device 30 selectively sprays moisture, mist or steam to the accommodating space 12.

Diverse components, which will be described later, are provided in the cabinet 10 and the accommodating space 12 is formed in the cabinet 10. The accommodating space 12 is in communication with outside selectively by a door 14. Various kinds of supporters 16 are provided in the accommodating space 12 to hang laundry thereon.

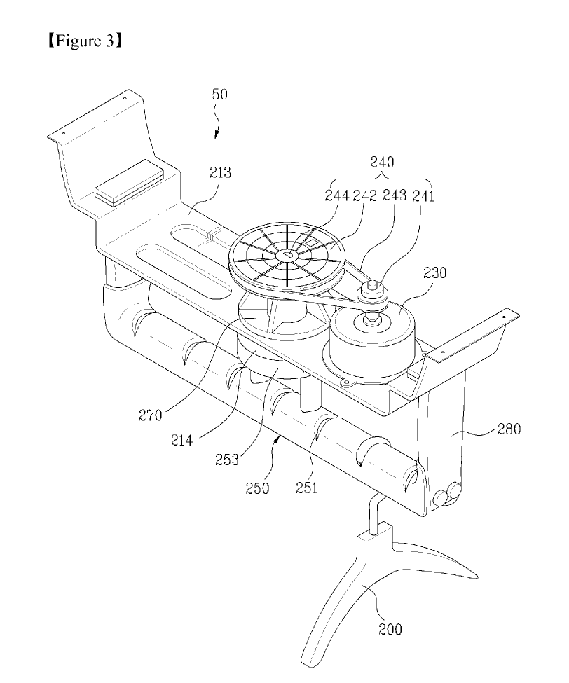

The supporter 16 keeps the laundry hung securely or fixedly without moving. Here, the supporter 16 may be configured to make the laundry move predeterminedly, if air, heated air, moisture, mist or steam is supplied to the laundry, which will be described in detail later in reference to FIGS. 2 and 3.

FIG. 2 is a front view of a laundry treating machine according to another embodiment of the present invention. In comparison to the above embodiment shown in FIG. 2, this embodiment presents a moving hanger capable of applying predetermined motion to the laundry, with the laundry hung thereon. As follows, this different feature will be described in detail.

In reference to FIG. 2, the moving hanger 50 is provided in the accommodating space 12, hung therein. Here, the moving hanger 50 may apply predetermined motion to the laundry. If air, heated air, moisture, mist or steam is supplied to the laundry, the laundry having the motion applied thereto may receive improved refreshing effectively.

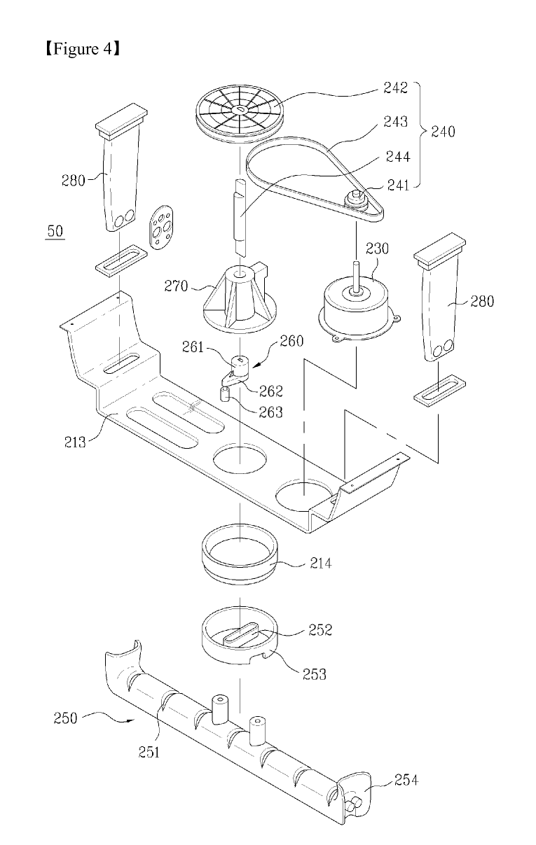

FIG. 3 is a perspective view illustrating the configuration of the moving hanger 50 and FIG. 4 is an exploded perspective view illustrating the moving hanger 50.

In reference to FIGS. 3 and 4, the moving hanger 50 includes a hanger bar 250 for supporting the laundry hung on hangers and supporting parts 280 for supporting both ends of the hanger bar 250. The hanger bar 250 includes a plurality of hanger recesses 251 and the hanger recess 251 fixes the position of the hanger 200, when the hanger 200 is hung on the moving hanger 50. The supporting parts 280 are supportedly connected to a moving hanger frame 213 and it is provided on a top of the cabinet 10, not seen when opening the door 14. Supporting ribs 254 are connected to both ends of the hanger bar 250, covering ends of the supporting parts 280, respectively. According to the laundry treating machine, the laundry hung on the hanger is received in the accommodating space 12 and the laundry treating machine is expected to have excellent drying efficiency as well as refreshing efficiency, compared with the conventional laundry treating machine.

Here, the moving hanger 50 includes a motor 230, a power converting part 260 and a power transmitting part 240. The power converting part 26 converts a rotational motion provided by the motor into a linear motion along a horizontal direction. The power transmitting part 240 transmits the power provided by the motor 230 to the power converting part 260.

The power transmitting part 240 includes a driving pulley 241 provided in the motor 230, a driven pulley 242 connected to the driving pulley 241 via a belt 243 and a shaft 244 secured to a center of the driven pulley 242. The shaft 244 is rotatably provided in a bearing housing 270 provided in the moving hanger frame 213.

The hanger bar 250 may further include slot 252 orthogonally provided with respect to its longitudinal direction. Specifically, a slot housing 253 is provided beyond the hanger bar 250 and the slot 252 is provided approximately in a center of the slot housing 253. the power converting part 260 includes a slot connected portion 263 inserted in the slot 252, a shaft coupling part 262 coupled to the shaft 244 and a rotation arm 262 connecting the slot connected portion 263 with the shaft connected portion 261. The power converting part 260 is covered by a cover 214 not to be visible outside and the cover 214 is provided between the moving hanger frame 213 and the slot housing 253.

With this configuration, once the motor 230 is rotated, the driving pulley 242 is rotated and the shaft 244 coupled to the driving pulley 242 is rotated, too. The slot connected portion 263 performs circular motion with a predetermined diameter.

On the other hand, the slot 252 provided in the hanger bar 250 is orthogonal to the longitudinal direction of the hanger bar 250 and the longitudinal of the slot 252 may be larger than a rotational locus of the slot connecting part 263. As a result, the slot 252 moves linearly in a horizontal direction, even when performing circular motion such that the hanger bar 250 connected to the slot 250 may move linearly in a horizontal direction.

A mechanism compartment 20 is provided in the cabinet 10 to accommodate an air supply device and a moisture generation device 30. The mechanism compartment may be provided under the accommodating space 12 and the air supply device 22 and the moisture generation device 30 are located in the mechanism compartment 20. The reason why the mechanism compartment 20 is located under the accommodating space 12 is that heated air and steam supplied to the accommodating space 12 have a characteristic of ascending. When the mechanism compartment 20 is located in a lower portion, it is more efficient to supply the heated air and steam upward to the accommodating space 12.

FIG. 5 is a perspective view schematically illustrating an inner configuration of the mechanism compartment 20. To illustrate the inner configuration of the mechanism compartment 20, FIG. 5 shows only the frame 11 defining an exterior appearance of the mechanism compartment 20 for convenience sake. Also, FIG. 5 shows key components including the air supply device 22 and the moisture generation device 30 for convenience sake and a pipe line connecting the key components with each other is not shown in FIG. 5.

In reference to FIG. 5, the air supply device 22 is located in the mechanism compartment 20 to supply air or heated air to the accommodating space 12.

A heat pump 22 corresponding to the air supply device according to this embodiment includes an evaporator 24, a compressor 26, a condenser 28 and an expansion valve (not shown) to circulate refrigerant and this structure dehumidify and heat air.

Specifically, latent heat of ambient air is absorbed while the refrigerant is evaporator 24 and air is cooled enough to condense and remove moisture contained in the air. While the refrigerant having passed the compressor 26 is compressed in the condenser 28, the latent heat is exhausted toward ambient air and the ambient air is heated. After that, the evaporator 24 and the condenser 28 are functioned as heat-exchanger such that the air drawn into the mechanism compartment 20 is dehumidified and heated via the evaporator 24 and the condenser 28 only to be supplied to the accommodating space 12.

The air heated by the heat pump 22 has a relatively low temperature, compared with the air heated by a conventional electric type heater but it may be dehumidified without using auxiliary dehumidifying devices. Because of that, the air re-supplied to the accommodating space 12 by the heat pump 22 is corresponding to relatively ‘low temperature dry air’. Here, ‘low temperature air’ does not mean that it has an absolutely low temperature but the air has a relatively lower temperature than the conventional hot air, even if it is heated air. The laundry treating machine according to this embodiment of the present invention supplies the low temperature dry air to the laundry. As a result, the laundry treating machine can prevent deformation or damage of the laundry which might occur because of the hot air during the refreshing or drying. The air supplied by the heat pump 22 of the laundry treating machine according to this embodiment has a relatively low temperature in comparison to the hot air supplied by the conventional laundry treating machine but it is dehumidified without using auxiliary dehumidifying devices. As a result, it is possible to dry and refresh more efficiently.

Specifically, an air inlet (21A, see FIG. 5) is formed in a front portion of an upper surface of the mechanism compartment 20 to draw air inside the accommodating space 12 into the mechanism compartment 20. A path for air flow is formed by the air inlet 21A and an inlet duct 29 connecting evaporator 24, condenser 28 and a fan 32. The air drawn into the mechanism compartment 20 by the inlet duct 29 via the air inlet 21A is dehumidified and heated, passing the heat pump 22, and the air is re-supplied to the accommodating space 12 via an outlet duct 33 and an air outlet 21B by the fan 32.

Here, although not shown in the drawings, a filter may be provided in the air inlet 21A. Since the air inlet 2A includes the filter, various foreign substances which might be contained in the air drawn into the mechanism compartment 20 can be filtered and fresh air can be supplied to the accommodating space 12.

In addition, the moisture generation device 30 is provided in the mechanism compartment 20 to supply moisture, mist and steam, which will be referenced to as ‘steam’ hereinafter, to the accommodating space 12.

The moisture generation device 30 includes a heater (not shown) for heating water to generate steam by heating water such that the generated steam may be supplied to the accommodating space 12. An external water tap and variations of it or water tank (not shown) may be used as water supply source to supply water to the moisture generation device 30. The water tank (not shown) may be provided in a predetermined portion of the mechanism compartment 20.

The water tank may be provided in a door module 60 installed in a predetermined portion of the mechanism compartment 20 and it may be detachable. Because of that, it is possible for the user to fill the water tank with water after separating and to reinstall the water tank later.

The steam generated in the moisture generation device 30 is supplied to the accommodating space 12 via a steam hose 36 and a steam nozzle (40, see FIGS. 1 and 2). It is more preferable if the steam hose 36 is shorter, to prevent the temperature of steam from decreasing while the steam is moving or to prevent the steam from being condensed. If the mechanism compartment 20 is located under the accommodating space 12, the steam nozzle 40 may supply steam via an upper portion, that is, a lower portion of the accommodating space 12.

A fan (not shown) may be provided in a rear portion of the mechanism compartment 20 and the fan blow external air of the mechanism compartment 20 into the mechanism compartment 20. Because of that, the temperature inside the mechanism compartment 20 may be prevented from increasing too high because of the operation of the heat pump 22 and the moisture generation device 30.

In the meanwhile, according to FIGS. 1 and 2, the door 14 of the laundry treating machine 100 seems to be rotatably coupled to a right side of the cabinet 1, seen in a front view. However, some users wish to install the door 14 in a left side of the cabinet 10. If the rotational direction of the door 14 has to be changed, a new hinge part supporting the door 14 rotatably has to be fabricated. If then, the production cost as well as the time will be increased disadvantageously. The present invention presents embodiments enabling the installation location of the door to be changed, in other words, enabling the existing hinge part to be used as it is without fabricating a new one, even if the rotational direction of the door is changed. First of all, hinge parts selectively provided in a couple of corners in upper and lower portions of the cabinet will be described. Then, hinge parts selectively provided in one of couples of corners in a diagonal direction of the cabinet will be described later.

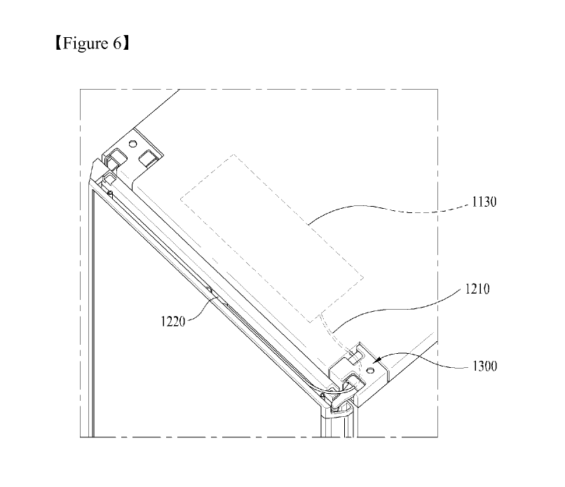

FIG. 6 is a perspective view illustrating the door 14 of the laundry treating machine according to present invention, see from the top.

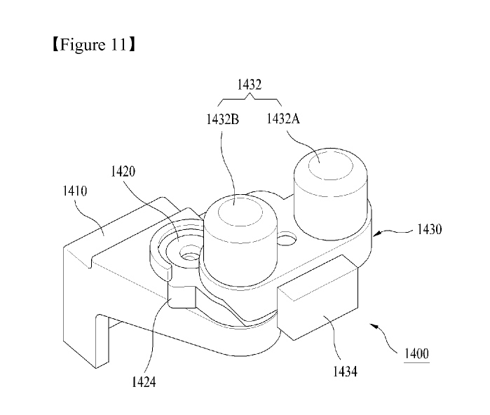

In reference to FIG. 6, the door 14 of the laundry treating machine 10 is supported by an upper hinge part (1300) and a lower hinge parts (1400, see FIG. 11) rotatably. The door 14 is rotatably coupled to the cabinet 10 by the upper and lower hinge parts 1300 and 1400. Here, the upper and lower hinge parts 1300 and 1400 may be versatile in right and left directions of the door with respect to upper and lower portions of the cabinet, to change an opening/closing direction of the door 14. A main control part 1130 is located in a top surface of the cabinet 10 to control various functions and parts. A wire 1210 which will be described later is connected to the main control part 1130 and the main control part 1130 controls operation of an input and display part (not shown) formed in a front surface of the door 14.

The wire 1210 connected to the input and display part is embedded in the door 14 and the wire 1210 is extracted from an upper end of the door via a wire extractor 1220 formed in the upper end of the door 14. Also, the wire 1210 is extended to the upper hinge part 1300 along the upper end of the door 14 only to be connected to the main control part 1130 via the upper hinge part 1300. As a result, the extension direction of the wire 1210 is changeable according to the position of the upper hinge part 1300, specifically, a right portion or left portion of the top surface of the cabinet. That is, if the upper hinge part 1300 is provided in the right portion of the cabinet 10, the wire 1210 passes the upper hinge part 1300 provided in the right portion of the cabinet as shown in a dotted line of FIG. 10, to be connected to the main control part 1130. if the upper hinge part 1300 is provided in the left portion of the cabinet 10, the wire 1120 passes the upper hinge part 1300 provided in the left portion as shown in a dotted line of FIG. 10, to be connected to the main control part 1130. The structure of this wire 1210 will be described in detail later.

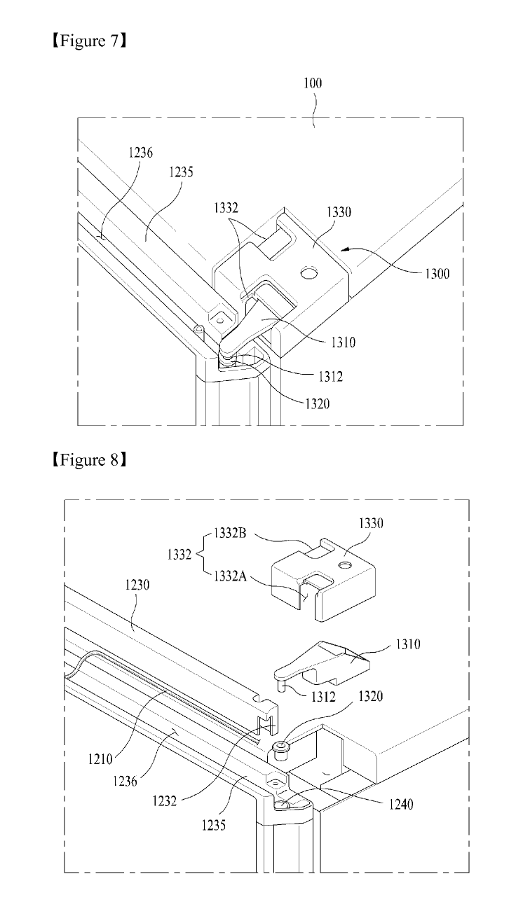

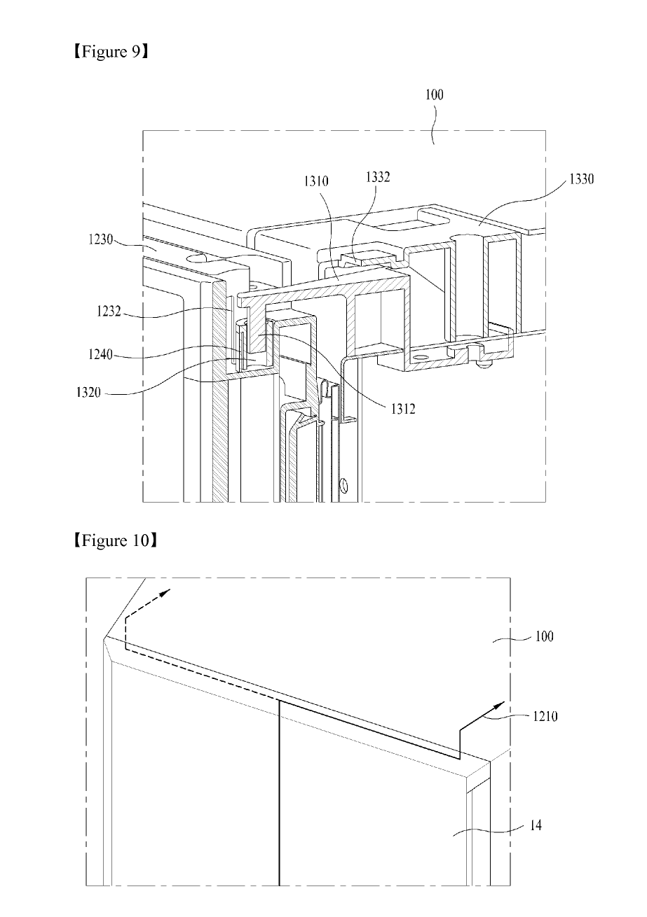

FIG. 7 is a perspective view illustrating the upper hinge part 1300 and FIG. 8 is an exploded view of FIG. 7 and FIG. 9 is a sectional view of FIG. 8.

In reference to FIGS. 7 to 9, the upper hinge part 1300 includes an upper hinge 1310 secured to a top surface of the cabinet 10. The upper hinge 1310 and a hinge cap 1330, which will be described later, are versatile in right and left portions of the top surface of the cabinet 10. For the right and left versatility, the upper hinge 1310 and the hinge cap 1330 may be bilaterally symmetrical.

An end of the upper hinge 1310 is connected to the cabinet 10 and the other end is extended toward the door. A cylindrical projection 1312 is projected downward from the extended end of the upper hinge 1310. A rotation supported part 1320 may be rotatably provided in an upper end of the door 14. As the projection 1312 is inserted in the door 14 together with the rotation supporting part 1320, the door 14 may be rotatable.

The rotation supporting part 1320 has a cylindrical hollow corresponding to the projection 1312 and it is inserted in the hinge inserting part 1240. The rotation supporting part 1320 is connected to the door 14 and the rotation supporting part 1320 is connected to the projection 1312 such that the door 14 may be rotatably coupled to the cabinet 10.

A hinge cap 1330 may be provided on the upper hinge 1310 and the hinge cap 1330 formed in a hexahedron shape with being open downward covers the upper hinge 1310 from the top. Hinge inserted grooves 1332 are formed in two neighboring sides of the hinge cap 1330, respectively. The hinge cap 1330 may be spaced apart a predetermined distance from the top of the upper hinge 1310, when secured to the upper hinge 1310. this is because the wire 1210 extracted from a wire extracting groove 1232 of a wire guide cover 1230, which will be described later, has to be connected to the main control part 1130 via the space formed between the top of the upper hinge 1310 and the hinge cap 1330.

The reason why the hinge inserting grooves 1332 are formed in the two neighboring sides, not two opposite sides, of the hinge cap 1330 is that the connection direction of the wire 1210 should be guided to the main control part 1130 smoothly when the hinge cap 1330 is used in right and left directions. When the hinge inserting grooves 1332 are formed in opposite sides of the hinge cap 1330, respectively, a connection path of the wire 1210 would be long. As a result, it is preferable that the hinge inserting grooves 1332 are formed in neighboring sides of the hinge cap 1330 for the guide of the wire 1210 and the right and left versatility of the upper hinge 1310. As shown in FIG. 8, in case the upper hinge 1310 is provided in the right top portion of the cabinet 10, the upper hinge 1310 is coupled to a right hinge inserting groove 1332A. The wire 1210 is inserted in the right hinge inserting groove 1332A and it passes the hinge cap 1330. Then, the wire 1210 is extracted from the left hinge inserting groove 1332B to be connected to the main control part 1130. Although not shown in the drawings, the upper hinge 1310 is coupled to the left hinge inserting groove 1332B and the wire 1210 is inserted in the left hinge inserting groove 1332B. Then, the wire 1210 passes the hinge cap 1330 and it is extracted from the right hinge inserting groove 1332A to be connected to the main control part 1130.

The wire 1210 extracted to the upper end of the door 14 via the wire extracting part 1220 of the door 14 is guided by a wire guide cover 1230. That is, the wire guide cover 1230 is configured to cover the upper end of the door 14 and it may have an open bottom to form a predetermined accommodating space capable of accommodating the wire 1210. In case the wire guide cover 1230 is connected to the top end of the door 14, the wire 1210 may be provided along an inner accommodating space, with extended toward the upper hinge part 1300. At this time, extracting grooves 1232 may be provided in both ends of the wire guide cover 1230, respectively, to extract the wire there from. Specifically, the wire 1210 extended along the quire guide cover 1230 is extracted through the extracting groove 1232 to be inserted in the hinge inserting groove 1332 of the hinge cap 1330 as mentioned above. Since the upper hinge part 1300 is versatile in right and left directions, the extracting grooves 1232 may be provided in both ends of the wire guide cover 1230, respectively. In case the upper hinge part 1300 is provided in the left top portion of the cabinet 10, the wire 1210 may be extracted from the extracting groove provided in the left ends of the wire guide cover 1230.

In the meanwhile, a receiving groove 1236 may be further provided in a top edge of the door 14 to receive the wire therein. The wire 1210 is received in the receiving groove 1236 to be extended along the right or left upper hinge part 1300 and the wire guide cover 1230 may cover the receiving groove 1236. the receiving groove 1236 may be integrally formed with the top of the door 14 or formed in an upper supporting part 1235 provided in the top of the door 14 as shown in FIGS. 7 and 8. If the upper supporting part 1235 is provided, the hinge inserting parts 1240 mentioned above may be provided in both ends of the upper supporting part 1235, not in the door 14.

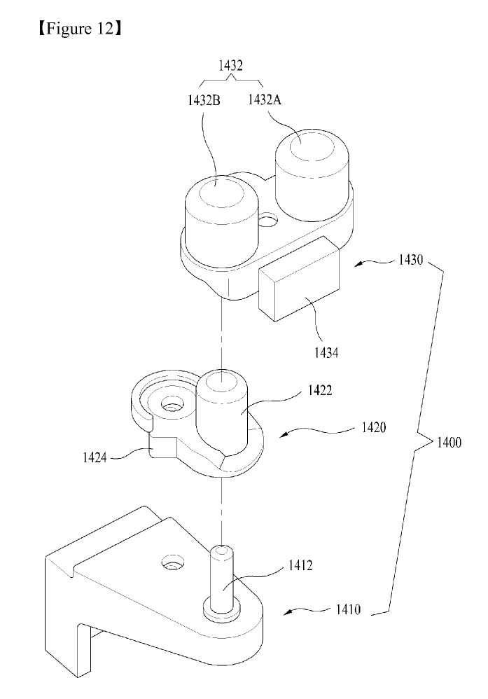

FIG. 11 is a perspective view illustrating the lower hinge part 1400 secured to the laundry treating machine and FIG. 12 is an exploded perspective view of FIG. 11.

In reference to FIGS. 11 and 12, the lower hinge part 1400 may include a lower hinge 1410 coupled to a bottom surface of the cabinet 10.

An end of the lower hinge 1410 is coupled to the lower portion of the cabinet 10 and the other end is extended toward the door 14. A cylindrical projection 1412 is projected upward from the extended end.

The lower hinge part 1400 may include a first cam member 1430 connected to a lower end of the door 14 and a second cam member 1420 connected to the first cam member 1430. The first and second cam members 1430 and 1420 are versatile in right and left portions of the bottom surface of the cabinet 10. For that, the second and first cam members 1420 and 1430 may be bilaterally symmetrical.

Specifically, a rotation supporting part 1422 is projected upward, corresponding to a projection 1412 of the lower hinge 1410. The rotation supporting part 1422 is cylindrical-shaped, with a hollow and the projection 1412 is inserted in the hollow. The second cam member 1420 may be secured to the lower hinge 1410 by a screw or the like and the first cam member 1430 is rotatably connected to a top of the rotation supporting part 1422. a couple of rotation limiting parts 1424A and 1424B may be provided in the second cam member 1420, on both sides of the rotation supporting part 1422, to limit a rotational angle of the first cam member 1430 and the rotation limiting part 1424 may be projected outward.

The first cam member 1430 may include a couple of rotating parts 1432 rotatably inserted in the rotation supporting part 1422. The rotating parts 1432 may be rotatably coupled to a left or right portion of the bottom surface of the door 14 selectively and they may have hollows corresponding to the rotation supporting part 1422 such that the rotation supporting part 1422 may be inserted in the hollows selectively. Specifically, the rotating part 1432 includes right and left rotating parts 1432A and 1432B. In case the lower hinge part 1400 is provided in the right portion of the bottom surface of the cabinet 10, the rotation supporting part 1422 is inserted in the right rotating part 1432A. In case the lower hinge part 1400 is provided in the left portion of the bottom surface of the cabinet 10, the rotation supporting part 1422 may be inserted in the left rotating part 1432B.

Here, a stopper 1434 may be provided between the couple of the rotating parts 1432 and the stopper 1434 is projected outward from an outer surface of the first cam member 1430. as a result, if the first cam member 1430 is rotated by the rotation of the door 14, the stopper 1434 interfere with either of the couple of the rotation limiting parts 1424 such that the rotational angle of the door 14 may be limited. If then, which rotation limiting parts 1424A and 1424B the stopper 1434 contacts with may be depending to whether the lower hinge part 1400 is installed in the right portion or left portion of the cabinet 10.

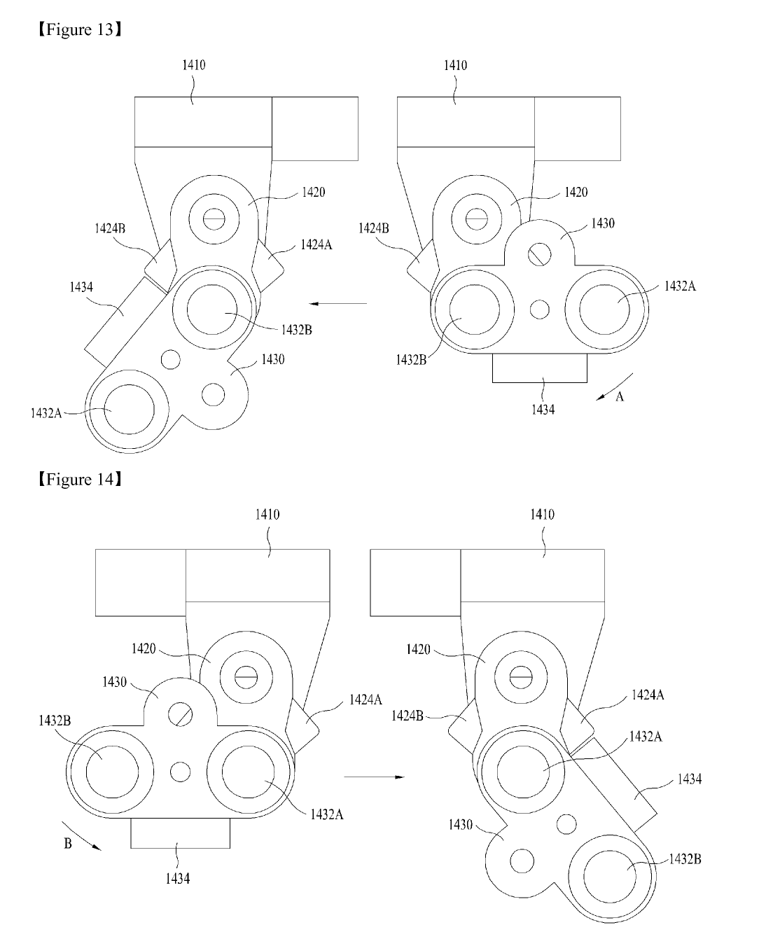

FIGS. 13 and 14 are operational diagrams illustrating operation of the laundry treating machine according to an opening direction of the door.

In reference to FIG. 13, if the lower hinge part 1400 is provided in the left portion of the bottom surface of the cabinet 10, the rotation supporting part 1422 may be inserted in the left rotating part 1432. In case the door is rotated along an arrow ‘A’ in a clockwise direction, the first cam member 1430 is rotated together with the door. If then, the first cam member 1430 is rotated in the clockwise direction, too. The rotation of the first cam member 1430 makes the stopper 1434 interfere with the left rotation limiting part 1424B of the couple of the rotation limiting parts to prevent no more rotation.

In reference to FIG. 14, if the lower hinge part 1400 is provided in the right portion of the bottom surface of the cabinet 10, the rotation supporting part 1422 may be inserted in the right rotating part 1432A. In case the door is rotated along an arrow ‘B’ in a counter-clockwise direction, the first cam member 1430 may be rotated together with the door. If then, the first cam member 1430 is rotated in the counter-clockwise direction, too. The rotation of the first cam member 1430 makes the stopper 1434 interfere with the right rotation limiting part 1424A to prevent no more rotation.

As follows, a hinge part selectively provided in one of two couples of corners in a diagonal direction of the cabinet will be described in reference to corresponding drawings.

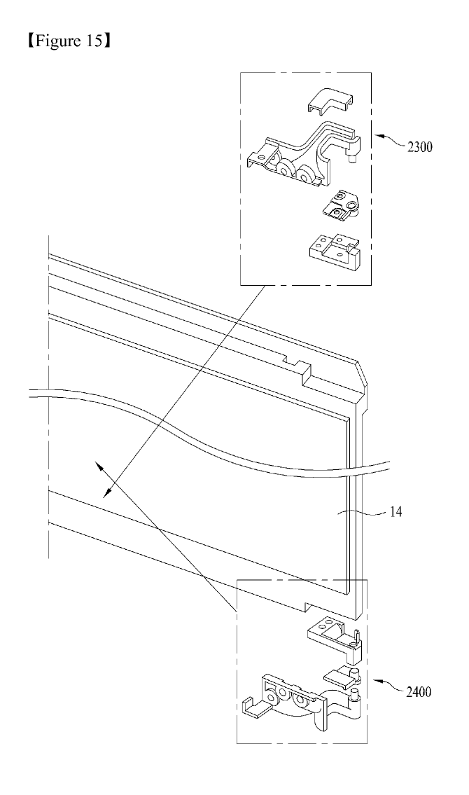

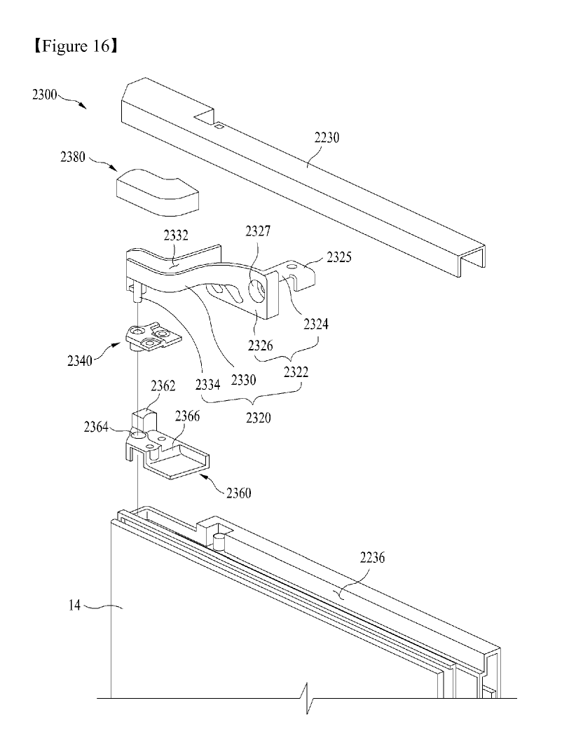

FIG. 15 is a perspective view illustrating the door rotatably connected to the cabinet 10 and FIG. 16 is an exploded perspective view illustrating the hinge part located in the top of the door.

In reference to FIGS. 15 and 16, the door 14 may be rotatably coupled to the cabinet 10 by a couple of hinge parts 2300 and 2400. The couple of the hinge parts 2300 and 2400 may be provided in right upper and lower portions or left upper and lower portions of the door, to make the door 14 rotatable. However, this embodiment presents the couple of the hinge parts 2300 and 2400 detachably provided in diagonally opposite corners of the door. That is, the couple of the hinge parts 2300 and 2400 may be selectively provided in a couple of diagonally opposite corners of the door 14.

As a result, the couple of the hinge parts 2300 and 2400 may include a first hinge part 2300 selectively provided in one of two couples of diagonally opposite corners of the cabinet 10 and a second hinge part 2300 provided in the other couple.

For example, the first hinge part 2300 may be secured to upper left or lower right portions of the cabinet selectively and the second hinge part 2400 may be secured to lower left or upper right portions of the cabinet 10 selectively. If the first hinge part 2300 is secured to the upper left portion of the cabinet 10, the second hinge part 2400 is secured to the lower left of the cabinet 10. If the first hinge part 2300 is secured to the lower right portion of the cabinet 10, the second hinge part 2400 may be secured to the upper right portion of the cabinet 10.

Since the couple of the hinge parts 2300 and 2400 may be selectively connected to the couple of the diagonally opposite corners, new hinge parts do not have to be fabricated in case of changing the rotational direction of the door. If the rotational direction of the door is changed according to a user's selection, for example, the rotational direction of the door 14 is changed into a left portion from a right portion of the cabinet 10, the couple of the hinge parts 2300 and 2400 are reconnected to diagonally opposite corners of the cabinet 10 only to reduce the production cost and time required to fabricate new hinge parts.

As follows, the first hinge part 2300 will be described in detail out of the couple of the hinge parts 2300 and 2400. The second hinge part 2400 may be symmetrically provided with respect to the first hinge part 2300 and a diagonal line and detailed description of the second hinge part 2400 will be omitted.

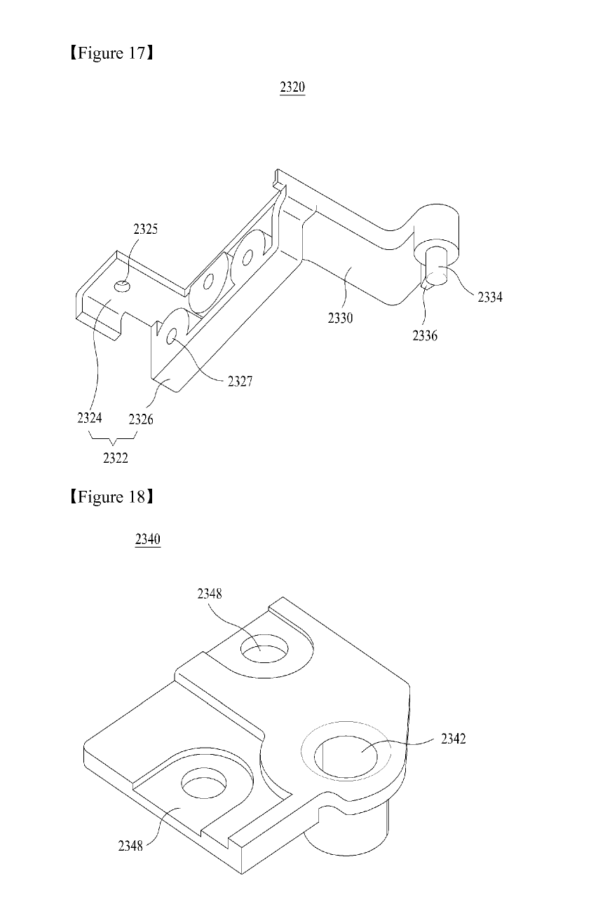

FIG. 17 is a low perspective view illustrating a first hinge 2320 of the first hinge part 2300. In reference to FIGS. 16 and 17, the first hinge part 2300 includes a first hinge 2320 and a rotation limiting part 2360. An end of the first hinge part 2300 is detachably secured to the upper left or lower right portion of the cabinet 10 and the other end is rotatably secured to the door 14. The rotation limiting part 2360 is provided in a top or bottom of the door 14 to limit a rotational angle of the door when the door 14 is rotated. Furthermore, the first hinge part 2300 may include a rotation supporting part 2340 secured to an upper left or lower right portion of the door 14 to support the first hinge 2320 rotatably.

The first hinge 2320 includes a connecting part 2322 coupled to a predetermined portion of the cabinet 10 and an extended part 2330 extended from the connecting part 2322 to be bent. The extended part 2330 may include a first projection 2334 rotatably inserted in the rotation supporting part 2340. The extended part 2330 is extended from the connecting part 2322 and bent at a predetermined portion thereof simultaneously. Since the extended part 2330 is extendedly bent from the connecting part 2322, the first hinge 2320 may be connected to the couple of the opposite corners of the cabinet selectively.

The connecting part 2322 may include a first connecting part 2324 connected to the top or bottom surface of the cabinet and a second connecting part 2326 connected to a front surface of the cabinet 10. as shown in FIG. 16, if the first connecting part 2324 is connected to the top surface of the cabinet 10, the extended part 2330 is bent in the predetermine direction and thus the first hinge 2320 may not be connected to the right and left portions of the cabinet along the top of the cabinet 10 but it may be connectable in a diagonal direction. If the first hinge 2320 is connected to the upper left portion of the cabinet 10, the first connecting part 2324 may be connected to the top surface of the cabinet. If the first hinge 2320 is connected to the lower right portion of the cabinet 10, the first connecting part 2324 may be connected to the bottom surface of the cabinet 10. Here, the second connecting part 2326 is supportedly connected to the front surface of the cabinet 10. the first and second connecting parts 2324 and 2326 include at least one securing holes 2325 and 2327, respectively, and a securing member (not shown) such as a bolt passes the securing holes 2325 and 2327 to be connected to the cabinet securely.

In the meanwhile, the first hinge 2320 may include a guide part 2343 to guide a wire (not shown) extended from the input and display part (not shown) of the door and extended from the top of the door 14. The laundry treating machine according to this embodiment includes the input and display part provided in a front surface of the door to allow the user to select a course and to display information. The information inputted via the input and display part is transmitted to a main control part provided on the top of the cabinet. The main control part controls the laundry treating machine 100 based on the inputted information and it controls the input and display part to display diverse information. The wire extended upward from the input and display part is bent toward the first hinge part 2300 from the top of the door and it passes the first hinge part 2300 to be connected to the top surface of the cabinet. That is, the wire is connected to the top surface of the cabinet 10 along the guide part 2332.

The guide part 2332 is provided along a top of the first hinge part 2320 and it may be a recess having a predetermined size to receive the wire. As a result, the wire is connected to the top of the cabinet 10, with received in the recess. If the wire is received in the guide part 2332, a closing member capable of closing an upper portion of the wire may be required to prevent the wire from separating from the guide part 2332. As a result, the first hinge part 2300 may further include a hinge cap 2380 detachably provided on the first hinge 2320.

The hinge cap 2380 is provided on the first hinge 2320 detachable to form a wire receiving space between the first hinge 2320 and itself. If the wire is received in the guide part 2332, the hinge cap 2380 is used to prevent the wire from separating from the guide part 2332. As a result, the wire is received along the space formed between the hinge cap 2380 and the first hinge 2320 to be connected to the top of the cabinet 10. At this time, since the extended part 2330 of the first hinge 2320 is bent, the hinge cap 2380 may be bent to correspond to the extended part 2330.

In the meanwhile, this embodiment presents that the wire is extended toward the first hinge 2330 along the top of the door 14, like the above embodiment. Specifically, a wire guide cover 2330 connected to the top of the door is provided to cover a top edge of the door 14. The wire guide cover 2230 may have a downward-open bottom to form the wire receiving space. The description of the wire guide cover 2230 is identical to that of the above embodiment and the repeated description will be omitted. The wire extracted from an extracting groove (not shown) of either of both ends of the wire guide cover 2230 is received along the space formed between the hinge cap 2380 and the first hinge 2320 to be connected to the main control part.

A receiving groove 2236 may be further provided in the top of the door 14 to receive the wire. The wire is extended along a right or left direction in a state of being received in the receiving groove 2236 and the wire guide cover 2230 may cover the receiving groove 2236. the receiving groove 2236 may be integrally formed with the top of the door as shown in FIG. 16 or provided in a top supporting part (not shown) provided in the top of the door 14.

FIG. 18 is a perspective view illustrating the rotation supporting part 2340.

In reference to FIG. 18, the rotation supporting part 2340 is seated on a rotation limiting part 2360 which will be described later. A groove 2342 where the first projection 2334 of the first hinge 2320 will be inserted is formed in the rotation supporting part 2340 and securing holes securing the rotation supporting part 2340 is formed near the groove 2342. As a result, the first projection 2334 of the first hinge 2320 is inserted in the groove 2342 for the door 14 to be rotatably connected.

If the door is open, the first hinge part 2300 is required to include a configuration capable of preventing the door from being open more than a predetermined angle. If the door 14 is open at more than a predetermined angle, the door 14 happens to collide against the cabinet 10 or other products installed next to the cabinet 10.

In reference to FIG. 16, the first hinge part 2300 may include a rotation limiting part 2360 for limiting the rotational angle of the door if the door 14 is open.

Specifically, the first hinge 2320 further includes a second projection and the rotation limiting part 2360 interferes with the second projection to limit the rotation of the door 14, when the door 14 is open. The rotation supporting part 230 is seated on the rotation limiting part 2360 as mentioned above. Because of that, the rotation limiting part 2360 includes a hole 2364 and the groove 2342 of the rotation supporting part 2340 is inserted in the hole 2364 of the rotation limiting part 2360. A step 2336 forming a predetermined space with the top or bottom of the door 14 may be provided in a predetermined portion of a rotation limiting part where the rotation supporting part 2340 is seated. This is because predetermined space had better to be formed for the first projection 2334 and the groove 2342 of the rotation supporting part 2340 not to contact with the top or bottom of the door 14.

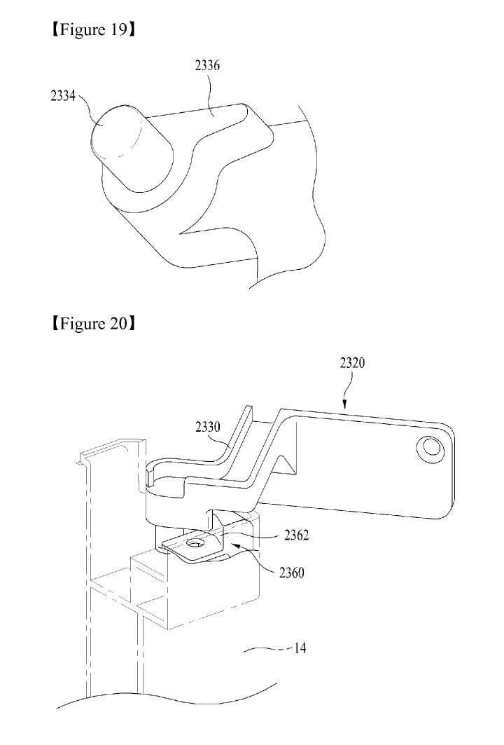

In the meanwhile, FIG. 19 is a perspective view illustrating the first projection 2334 and the second projection 23336 formed in the end of the first hinge 2320, seeing the end of the first hinge 2320 from the bottom.

In reference to FIG. 19, the first projection 2334 is projected downward from the end of the extended part 2330 and the second projection 2336 is projected from the first projection 2334. If the door 14 is open only to rotate the first hinge 2320, the second projection 2336 is interfered with by a limiting part 2362 of the rotation limiting part 2360 and the rotation of the first hinge 2320 is limited at a predetermined angle or more.

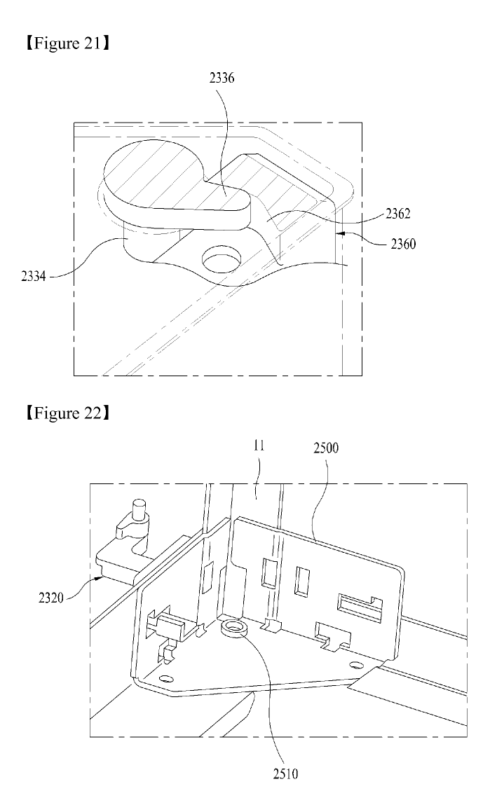

FIGS. 20 and 21 show that the rotation limiting part 2360 limits the first hinge 2320 to rotate at a predetermined angle or more. FIG. 10 is a perspective view partially illustrating only the first hinge 2320 and the rotation limiting part 2360 and FIG. 21 is a sectional view of FIG. 20.

In reference to FIGS. 20 and 21, if the door is open to rotate, the second projection 2336 of the first hinge 2320 is interfered with by the limiting part 2362 of the rotation limiting part 2360 such that the door 14 is prevented from rotated no more.

If the door is coupled to the front surface of the cabinet 10, the door 14 would droop because of its load and this droop would generate deformation of the cabinet. Because of that, the door 14 is required to include a configuration capable of preventing the droop.

FIG. 22 is a perspective view illustrating the first hinge 2320 connected to the frame 11 of the cabinet 11.

In reference to FIG. 22, a reinforcing bracket 2500 connected to the first or second hinge part 2300 and 2400 may be provided in the cabinet 10 to prevent the droop of the first or second hinge part 2300 and 2400. The reinforcing bracket 2500 is formed in an inner surface of the frame 11 in a shape corresponding to the frame 11 and it is fixed to the frame 11 by a fixing member such as a bolt. The first hinge 2320 is secured, passing through the frame 11 and the reinforcing bracket 2500, and it may be securely fixed by the reinforcing bracket 2500.

In the meanwhile, when provided in the bottom of the cabinet 10, the first hinge part 2300 or second hinge part 2400 will be adjacent to a leg (not shown) provided in the bottom surface of the cabinet 10. as a result, if the reinforcing bracket 2500 is provided in the inner surface of the frame 11 of the cabinet 10, the reinforcing bracket 2500 are the leg would interfere with each other. Because of that, a through hole 2510 is provided in the reinforcing bracket 2500 and at least one leg passes the through hole 2510 of the reinforcing bracket 2500 provided in the lower portion of the cabinet 10.

The configuration of the first hinge part 2300 has been described in reference to FIGS. 15 to 32. The second hinge part 2400 is diagonal to the first hinge part 2300, that is, symmetrical with respect to the couple of opposite corners of the front surface of the cabinet and the detailed description of the second hinge part 2400 will be omitted.

### INDUSTRIAL APPLICABILITY

The present invention has an industrial applicability. According to the laundry treating machine according to the present invention, if the user wishes to change the rotational direction of the door when connecting the door to the cabinet, the only thing he/she has to do is to change the locations of the hinge parts, without fabricating any new hinge parts. As a result, the fabrication assembly may be simple and efficient. In addition, the production cost may be reduced when fabricating the laundry treating machine.

1. A laundry treating machine comprising:
a cabinet comprising an accommodating space formed therein to accommodate laundry;
a door rotatably coupled to a front surface of the cabinet;
an air supply device for supplying air or heated air to the accommodating space; and
first and second hinge parts, the first hinge part selectively provided in one of two couples of diagonally opposite front corners of the cabinet and the second hinge part provided in the other one.

2. The laundry treating machine as claimed in claim 1, wherein the first hinge part is selectively provided to an upper left portion or a lower right portion of the cabinet to support the door rotatably and the second hinge part is selectively provided to a lower left portion or upper right portion of the cabinet to rotatably support the door.

3. The laundry treating machine as claimed in claim 1, wherein the first hinge part comprises,
a first hinge including an end detachable provided to an upper left portion or a lower right portion of the cabinet and the other end rotatably provided to the door; and
a rotation limiting part provided in a top or bottom of the door to limit a rotational angle of the door when the door is rotated.

4. The laundry treating machine as claimed in claim 3, wherein the first hinge part further comprises,
a rotation supporting part provided to an upper left portion or a lower right portion of the door to support the first hinge rotatably.

5. The laundry treating machine as claimed in claim 4, wherein the first hinge comprises,
a connecting part connected to a predetermined portion of the cabinet; and
an extended part bently extended from the connecting part, the extended part comprising a first projection inserted in the rotation supporting part rotatably.

6. The laundry treating machine as claimed in claim 5, wherein the first hinge further comprises,
a guide part to guide a wire extended from an input and display part of the door and extracted from the top of the door.

7. The laundry treating machine as claimed in claim 6, wherein the guide part is provided on a top of the first hinge.

8. The laundry treating machine as claimed in claim 7, further comprising:
a hinge cap detachably provided on the first hinge, the hinge cap forming a receiving space with the first hinge to receive the wire.

9. The laundry treating machine as claimed in claim 8, wherein the hinge cap is bent, corresponding to the extended part.

10. The laundry treating machine as claimed in claim 9, wherein the wire is connected to the top of the cabinet along the space formed between the hinge cap and the first hinge.

11. The laundry treating machine as claimed in claim 6, further comprising:
a wire guide cover provided on a top edge of the door to guide the wire.

12. The laundry treating machine as claimed in claim 11, wherein the wire is extended from a center of the top edge of the door toward the first hinge part along the wire guide cover.

13. The laundry treating machine as claimed in claim 11, wherein the wire guide cover comprises
a receiving space for receiving the wire; and
a extracting groove formed in both ends thereof to extract the wire.

14. The laundry treating machine as claimed in claim 11, further comprising;
a receiving groove provided in a top edge of the door, wherein the wire guide cover covers the receiving groove.

15. The laundry treating machine as claimed in claim 14, further comprising:
an upper supporting part provided in the top edge of the door to foam the receiving groove therein.

16. The laundry treating machine as claimed in claim 5, wherein the connecting part comprises a first connecting part connected to the top or bottom of the cabinet and a second connecting part connected to a front surface of the cabinet.

17. The laundry treating machine as claimed in claim 4, wherein the first hinge further comprises a second projection and the rotation limiting part comprises a limiting part interfered by the second projection to limit the rotation of the first hinge when the door is rotated.

18. The laundry treating machine as claimed in claim 3, wherein predetermined space is formed between a predetermined portion of the rotation limiting part and the top or bottom of the door.

19. The laundry treating machine as claimed in claim 1, wherein the second hinge part comprises,
a second hinge including an end detachable provided to a lower left portion or an upper right portion of the cabinet and the other end rotatably provided to the door; and
a rotation limiting part provided in a top or bottom of the door to limit a rotational angle of the door when the door is rotated.

20. The laundry treating machine as claimed in claim 19, wherein the second hinge part further comprises,
a rotation supporting part provided to a lower left portion or an upper right portion of the door to support the first hinge rotatably.

21. The laundry treating machine as claimed in claim 20, wherein the second hinge comprises,
a connecting part connected to a predetermined portion of the cabinet; and
an extended part bently extended from the connecting part, the extended part comprising a first projection inserted in the rotation supporting part rotatably.

22. The laundry treating machine as claimed in claim 21, wherein the second hinge further comprises,
a guide part to guide a wire extended from an input and display part of the door and extracted from the top of the door.

23. The laundry treating machine as claimed in claim 22, wherein the guide part is provided on a top of the second hinge.

24. The laundry treating machine as claimed in claim 23, further comprising:
a hinge cap detachably provided on the second hinge, the hinge cap forming a receiving space with the second hinge to receive the wire.

25. The laundry treating machine as claimed in claim 24, wherein the hinge cap is bent, corresponding to the extended part.

26. The laundry treating machine as claimed in claim 25, wherein the wire is connected to the top of the cabinet along the space formed between the hinge cap and the second hinge.

27. The laundry treating machine as claimed in claim 22, further comprising:
a wire guide cover provided on a top edge of the door to guide the wire.

28. The laundry treating machine as claimed in claim 27, wherein the wire is extended from a center of the top edge of the door toward the second hinge part along the wire guide cover.

29. The laundry treating machine as claimed in claim 27, wherein the wire guide cover comprises
a receiving space for receiving the wire; and
an extracting groove formed in both ends thereof to extract the wire.

30. The laundry treating machine as claimed in claim 27, further comprising;
a receiving groove provided in a top edge of the door, wherein the wire guide cover covers the receiving groove.

31. The laundry treating machine as claimed in claim 30 further comprising:
an upper supporting part provided in the top edge of the door to form the receiving groove therein.

32. The laundry treating machine as claimed in claim 21, wherein the connecting part comprises a first connecting part connected to the top or bottom of the cabinet and a second connecting part connected to a front surface of the cabinet.

33. The laundry treating machine as claimed in claim 20, wherein the second hinge further comprises a second projection and the rotation limiting part comprises a limiting part interfered with by the second projection to limit the rotation of the second hinge when the door is rotated.

34. The laundry treating machine as claimed in claim 19, wherein predetermined space is formed between a predetermined portion of the rotation limiting part and the top or bottom of the door.

35. The laundry treating machine as claimed in claim 1, further comprising:
a reinforcing bracket provided in the cabinet, connected to the first and second hinge parts, to prevent the first and second hinge parts from drooping.

36. The laundry treating machine as claimed in claim 35, wherein at least one leg provided in the laundry treating machine is provided through the reinforcing bracket provided in a lower portion of the cabinet.
